(19) United States
(12) Patent Application Publication
(10) Pub. No.: US 2013/0037515 A1
(43) Pub. Date: Feb. 14, 2013

(54) SAPPHIRE POLISHING SLURRY AND SAPPHIRE POLISHING METHOD

(71) Applicants: Daisuke Hosoi, Narashino-shi (JP); Takashi Shigeta, Narashino-shi (JP)

(72) Inventors: Daisuke Hosoi, Narashino-shi (JP); Takashi Shigeta, Narashino-shi (JP)

(73) Assignee: BAIKOWSKI JAPAN CO., LTD., Narashino-shi, Chiba, (JP)

(21) Appl. No.: 13/643,404

(22) PCT Filed: Apr. 27, 2011
(86) PCT No.: PCT/JP2011/060684

§ 371 Date: Oct. 25, 2012

(30) Foreign Application Priority Data
Apr. 28, 2010 (JP) 2010-103886

(51) Int. Cl. C09K 13/00; B44C 1/22

(52) U.S. Cl. 216/53; 252/79.1

(57) ABSTRACT

Disclosed is a polishing slurry for sapphire polishing that is capable of obtaining polishing speeds and smooth surfaces during the polishing of sapphire substrates that are equivalent to or better than in prior polishing processes even if the number of polishers and polishing hours are reduced. Also disclosed is a sapphire substrate polishing method. The slurry includes alumina abrasives and has a pH adjusted to the range of 10.0 to 14.0, and the sapphire is polished by means of the CMP technique by applying said slurry. The aforementioned alumina abrasives more preferably include at least α-alumina, and the content thereof is more preferably 0.01 to 50 wt %. The mean particle size of the aforementioned alumina abrasives is preferably 0.05 to 10 μm.

### TECHNICAL FIELD

This invention relate to a sapphire polishing slurry to be used in surface polishing process of the sapphire used mainly for electronic components, optical parts, watches, electrically insulating material, window material, and relate a sapphire polishing method.

### BACKGROUND TECHNIQUE

In recent years, with the spread of the LED to be expected as next-generation lighting, the demand for sapphire used as its substrate material has been increasing more and more. Most of the current LED is produced as a base GaN film grown on the sapphire substrate, therefore, for use as a substrate of the LED, the polishing of sapphire surface is an essential process. However, sapphire polishing is difficult and also takes a long time, because sapphire is chemically very stable and it is a very hard material with 9 Mohs hardness, and it is costly because a new polishing facility must be introduced to increase the amount of its supply. In addition, diamond abrasive grain that are used for the sapphire polishing is currently expensive and that is a cause of raising the polishing cost of sapphire. Therefore, it is a pressing need to reducing the production cost of sapphire substrate for LED, to increase the supply amount of the sapphire substrate still reduce the manufacturing cost, improvement such as the reduction in the polishing man-hour and shortening the polishing time, are desired.

By the way, the sapphire polishing process is further required at least two steps or more from the state before polishing (for example, the state after finishing the first machining process such as the primary example lapping with SiC). As before the finish polishing processing, the sapphire finished with the primary machining, is polished using for example diamond abrasive grain and a hard plate comprising such as copper and tin. And in addition, planarizing the surface of the sapphire by chemical action and mechanical action, namely Chemical Mechanical Polishing (CMP).

The final polishing processing of sapphire substrate, which is sapphire polishing method using polishing slurry including colloidal silica, have been proposed in several prior art. For example, a method of polishing a sapphire substrate using a polishing slurry comprising colloidal silica for CMP adjusted its pH and zeta potential, is disclosed in JP-A-2009-28814.

However, in the conventional polishing method using a colloidal silica or silicon oxide including the method described in JP-A-2009-28814, the polishing speed is still insufficient, and the polishing speed sufficient to omit the pre-polishing step before finishing process, and enable to reduce the processing time and number of the processing steps, cannot be obtained.

### DISCLOSURE OF THE INVENTION

### Problems to be Resolved by the Invention

The present invention was made in view of the above circumstances. The object of the present invention is to provide a polishing slurry for sapphire polishing, which can obtain a polishing speed and a smooth surface equivalent to or greater than that of the prior art upon sapphire polishing, and a method for polishing a sapphire.

### Means for Solving the Problems

The inventors of this invention have extensively studied the relation between the composition of the polishing slurry and polishing speed, and characteristics of the polished surface of the sapphire, when a sapphire substrate is polished using the slurry by CMP. As a result, it was found that when using alumina instead of colloidal silica as abrasive grain to be contained in the polishing slurry and controlling the pH of the slurry to specific values in a strong alkaline region, especially, the polishing speed is significantly improved and man-hours of polishing process can be reduced.

(1) A sapphire polishing slurry of the present invention is characterized in that said slurry contains alumina abrasive grains and the pH of the slurry is in a rage from 10.0 to 14.0, more preferably from 11.5 to 13.5.

(2) The sapphire polishing slurry of the present invention described in item (1) is characterized in that said slurry contains alumina abrasive grain from 0.01 to 50 wt %, more preferably from 1 to 15 wt %.

(3) The sapphire polishing slurry of the present invention described in item (1) or (2) is characterized in that the mean particle size of said alumina abrasive grains is from 0.05 to 10 μm.

(4) The sapphire polishing slurry of the present invention described in any item (1) to (3) is characterized in that the alpha conversion ratio of alumina crystalline phase contained in said alumina abrasive grain, is from 1 to 100%.

(5) A sapphire polishing method of the present invention is characterized in that the surface of the sapphire is polished by means of Chemical Mechanical Polishing (CMP) using the sapphire polishing slurry described in any item (1) to (4).

### Effect of the Invention

According to the polishing slurry of the present invention comprising a alumina-based abrasive grains and adjusting said slurry to strong alkaline region of pH from 10.0 to 14.0, and a sapphire polishing method using said slurry, it is possible to obtain a polished surface finish equivalent to the case of polishing by conventional methods using the polishing slurry based on silica, at the faster polishing speed as compared to conventional polishing method using the conventional polishing slurry. Therefore, it is possible to shorten the time of polishing.

Further, upon obtaining the sapphire having desired surface roughness, because it is possible to omit the step of pre-finishing process using colloidal silica or the like, and we can finish the conventional sapphire polishing step, which has been carried out at least two or more steps, at one step. Therefore, according to the present invention, the polishing time is considerably shortened and significant reduction of the cost for polishing can be achieved.

### BRIEF DESCRIPTION OF THE DRAWING

FIG. 1 is the graph showing correlation between the pH of each used slurry and the polishing speed of sapphire by using the slurry including alumina abrasive grain and colloidal silica, respectively.

FIG. 2 is the graph showing correlation between the percentage of alpha alumina crystalline phase of alumina abrasive grain and the polishing speed of sapphire.

### A MODE FOR IMPREMENTING THE INVENTION

Hereafter, the present invention will be describes in detail.

The sapphire polishing slurry of the present invention (hereinafter referred to as polishing slurry of this invention) contains alumina abrasive grain and has the pH range of from 10.0 to 14.0, and said slurry is obtained by suspending alumina particles in an aqueous solution as polishing abrasive grains and adjusting the pH of the slurry to the range from 10.0 to 14.0.

PH of the slurry containing alumina abrasive grains is adjusted with pH adjusting agent, for example such as sodium hydroxide (NaOH) and potassium hydroxide (KOH). It is needless to say that the pH adjusting agent used in the present invention, other alkaline chemical compounds other than KOH and NaOH are sufficient as the pH adjusting agent if it enables the pH of the polishing slurry to adjust to the range from 10.0 to 14.0. In order to improve the dispersibility of alumina abrasive particles in the slurry of the present invention, dispersing agents such as an anionic surfactant may be added.

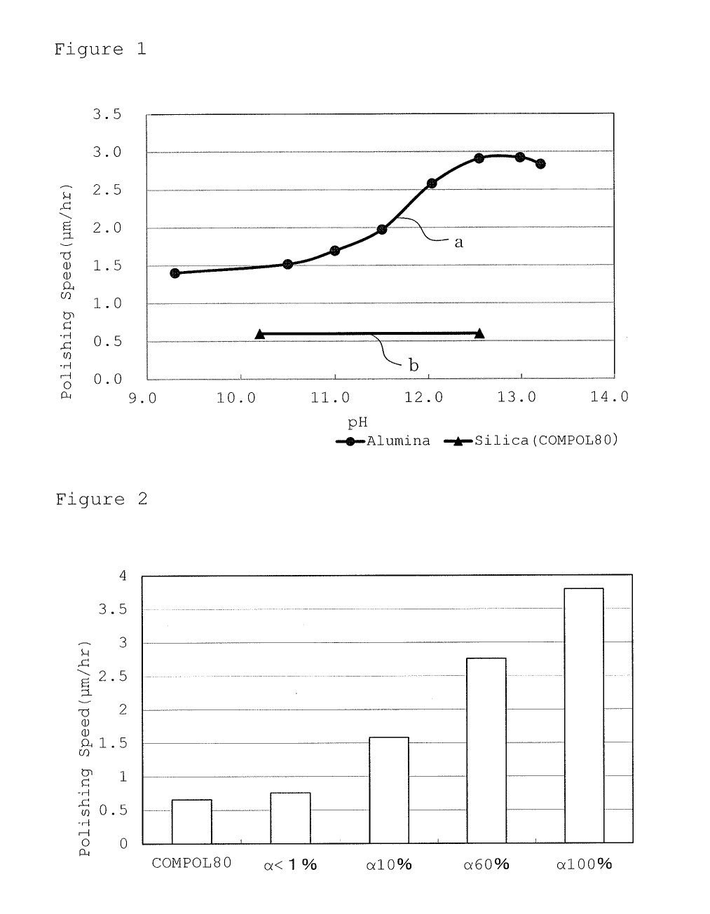

FIG. 1 shows the result of relation between pH of the polishing slurry and the polishing speed (removed thickness per hour: μm/hr) when sapphire is polished by the polishing method of this invention (hereinafter referred to as polishing method of this invention). The vertical axis of FIG. 1 is polishing speed (μm/hr) and the horizontal axis of FIG. 1 is pH of the slurry used for polishing. In FIG. 1, the curve a shows the result when using the slurry containing 2 wt % of alpha alumina (alpha crystalline phase content=100%) of which mean particle size is 0.25 μ m, and the curve b shows the result when using the colloidal silica slurry containing 20 wt % of silicon dioxide. In addition, polishing was altogether operated on the same conditions as the following example 1 using CMP polishing machine.

As can be seen from a comparison of curves a and b of FIG. 1, in the case of using alumina abrasive grains (curve a), the polishing speed increase in the polishing slurry of pH more than 10. The polishing speed significantly increases in the polishing slurry of pH greater than 11, and is saturated in the strong alkaline slurry of pH greater than about 12.5.

On the other hand, in the case of using conventional slurry including colloidal silica (curve b), only about ⅓ to ⅕ of polishing speed was obtained comparing to the polished case using the polishing slurry containing alumina abrasive. Furthermore, the polishing speed showed no difference even if pH of the slurry exceeded 10 or 12.5. That is, even if the pH of used slurry is high in an alkali domain, the polishing speed did not rise.

That is, when performing sapphire polishing, by using the slurry of the present invention, the polishing speed of about 5 times of the conventional colloidal silica is obtained, and final polishing time can be shortened to one fifth. In addition, even if pH is 13.5 or more, there is almost no fall of polishing speed, but since it is necessary to add an alkaline component in large quantities in order to adjust pH, becoming a factor of a cost overrun and alumina particles aggregation and it becomes a cause of polish scratch generating, it is not desirable.

Therefore, the polishing slurry of the present invention should be adjusted in the region of pH 10.0 to 14.0, preferably to pH 11.5 to 13.5.

In the slurry for polishing of the present invention which contains alumina abrasive and adjusted the pH to the range of from 10.0 to 14.0, making alumina abrasive contains about only 0.01% of the weight to the slurry, the polishing speed becoming quick and polishing speed further improving with the increase in the content of alumina grains rather than polishing by the conventional slurry for polishing which consists of colloidal silica, but even if the alumina abrasive is contained 50% of the weight or more, the effect hardly changes.

Therefore, as for the quantity of the alumina abrasive which the slurry for polishing of the present invention is made to contain, it is desirable to consider it as 0.01 wt % or more in respect of polishing speed, and to consider it as 50 wt % or less from a viewpoint of polishing cost, and it is more desirable to consider it as 1 to 15 wt % especially.

Moreover, as alumina grains which the slurry for polish of the present invention is made to contain, if the diameter of a particle is below 0.05 μm, sufficient polishing speed will not be obtained, and if it is 10 μm or more, it will become a cause of polish scratches, and the polish surface satisfactory as final polishing is not obtained. Therefore, as for the alumina abrasive used for the slurry for polishing of the present invention, the alumina abrasive having a mean particle size from 0.05 to 10 μm, is desirable.

The alumina grain used is desirable whose alpha content of alumina crystalline phase is 1% or more also especially in the point which may raise polishing speed more to alumina. Even if it adjusts pH of a slurry to 11 or more, when alumina whose alpha content of the case where a crystalline phase uses alumina other than alpha phase, and an alumina crystalline phase, such as gamma alumina and beta alumina, is less than 1% is used, only the polishing speed about colloidal silica and equivalent is obtained as an abrasive grains.

In the present invention, alpha conversion ratio of alumina crystalline phase (the alpha content of the alumina crystalline phase) means the rate that alpha phase in the crystalline phase of an alumina grains occupies, and the alpha conversion ratio of alumina crystalline phase (the alpha content of the crystalline phase of the used alumina grains) was measured by the diffraction spectrum of the alumina grain using powder x-ray diffraction equipment, and computed it from the following formula (1) as follows.
S: the peak integration count number between 2 theta=55.8° and 58.9° of the diffraction spectrum of a sample,
TS: time required for measurement of count number S,
BN1: count number at 2 theta=55.8°,
BN2: count number at 2 theta=58.9°, and
TBN: the time required for measurement of BN1 count and BN2 count.
Using above each value, Peak area (SP)=S−BN, is computed from background noise (BN)=(BN1+BN2)/2×(TS/TBN). And when the Peak area obtained by measuring in the same manner about the sample of 100% of an alpha conversion rate, is set to S 100,

alpha conversion rate (%)=(SP/S100)×100. (1)

FIG. 2 is a graph showing the relationship between the alpha conversion ratio of alumina abrasive grain in each polishing slurry and polishing speed (when sapphire was polished using each slurry). In used each polishing slurry, 2 weight % of alumina abrasive grain having different alpha conversion ratio was included respectively, and the pH of the slurry was adjusted to 12.5 by KOH. And the sapphire was polished using each polishing slurry and the polishing speed at that time was measured in the same manner as the case shown in FIG. 1. In FIG. 2, the horizontal axis represents the alpha conversion ratio of alumina abrasive grain in the used each polishing slurry, and the vertical axis represents the polishing speed, respectively.

As can be seen from FIG. 2, when the alumina abrasive grain of the alpha conversion ratio is 1%, the polishing speed was almost the same as the polishing at the same manner except the sluryy containing colloidal silica (shown in the bar graph at the left end, in the case of COMPOL 80) was used, but the polishing speed was increased with increasing the alpha conversion ratio of alumina crystal phase in the polishing abrasive grain, and when the abrasive grain consisting of only alpha alumina was used (shown in the bar graph at the right end, in the case alpha conversion ratio is 100%), the polishing speed was maximized.

From these results, in the view point that the polishing speed can be further improved compared with the polishing using the slurry coprising conventional colloidal silica as the abrasive grain, the alumina whose alpha conversion ratio is from 1 to 100 weight % (that is, the alumina whose alpha conversion ratio of the alumina crystal phase, is at least 1 weight %) is preferable, and the alumina abrasive grain consisting of only alpha alumina is more preferably used.

Further, even if using the alumina abrasive grain mixed in advance alpha alumina and alumina having crystal phase except alpha phase, when the alpha conversion ratio of total abrasive grain calculated by the above-mentioned calculation method, is 1% or more, it was confirmed that there is a correlation similar to FIG. 2 between the alpha conversion ratio of alumina abrasive grain in the polishing slurry and polishing speed. Therefore, as the abrasive grain in the present invention, it is also possible to use those obtained by mixing a predetermined amount of alumina having different crystal phase.

The sapphire polishing method of the present invention is characterized to polish the surface of the sapphire by Chemical Mechanical Polishing (CMP) using the sapphire polihing slurry of present invention, and to polish by similar method to the conventional sapphire polishing method except using the polishing slurry of present invention.

For example, holding the sapphire which is the object to be polished, by the template provided in the single side polisher, and dropping the slurry of present invention on a polishing cloth or polishing pad attached on the polishing plate provided in the polisher, the surface of sapphire is polished by carrying out relative motion together.

As the polishing apparatus, a double side polisher can also be used. In the case of using a double side polisher, holding the sapphire which is the object to be polished, in the carrier provided in the double side polisher, and inserting the polishing slurry of present invention between the polishing cloth or pad attached on both the upper polishing plate and lower polishing plate provided in the polisher, the surface of sapphire is polished by carrying out relative motion together.

### EXAMPLES

The following examples are given in order to illustrated the present invention in detail without limiting the technical scope to these examples.

### Example 1

2 part by weight of pre-dispersed alpha alumina abrasive grains having an mean particle diameter of 0.25 pm, was dispersed in 98 parts by weight of water, and adjusted the pH of the slurry to 12.55 by adding potassium hydroxide into the slurry containing the alpha alumina abrasive grains. Thus, polishing slurry of Example 1 containing 2 part by weight of alumina abrasive grains whose alpha conversion ratio is 100%, was prepared.

Then, using the single side polishing apparatus attached polishing pad SUBA 600 (manufactured by Nitta Haas Co.) on its polishing plate of 15 inches φ, loading the sapphire, the object to be polished, on the template, and while supplying the slurry of Example 1 between the polishing plate, the sapphire was polished for 60 minutes at the number of rotation 60 rpm of polishing plate and at polishing pressure of 300/cm².

In that case, for the sapphire to be polished, the weight difference of the sapphire between before polished one and after polished one, was measured using precision balance (Model AG 204 manufactured by Mettler TOLEDO Co.), and from said weight difference of the sapphire, the polishing speed was obtained by calculating the thickness of polished sapphire. As a result, the polishing speed was 3.4 pm / h r .

### Example 2

The polishing slurry of Example 2 was prepared in the same manner as the polishing slurry of Example 1, except that the pH of the slurry alpha dispersed alumina was adjusted to 13.21 by adding sodium hydroxide in place of potassium hydroxide.

Then, the sapphire was polished under the same conditions as in Example 1 except using the polishing slurry of Example 2 insted of Example 1 as polishing slurry. The polishing speed at that time, was 2.8 μm/hr.

In addition, when the central line average surface roughness (Ra) of the polished sapphire surface was measured using AFM (MODEL VN-8000 manufactured by KEYENCE Co.), the Ra at that time, was 0.496 nm.

### Comparative Example 1

In place of alumina abrasive grains, the polishing slurry of Comparative Example 1 was prepared by diluting the slurry of colloidal silica having a particle size of from 62 to 82 nm (Compol 80, manufactured by FUJIMI INCORPORATED), to 1:1 with purified water. The pH of the obtained slurry was 10.2.

Then, under the same conditions as in Example 1 except used the slurry of Comparative Example 1 in place of Example 1, the polishing speed was 0.6 μm/hr.

### Comparative Example 2

By adding sodium hydroxide to the slurry of Comparative Example 1 and adjusting the pH to 12.55, the slurry of Comparative Example 2 was prep aired.

Then, under the same conditions as in Example 1 except used the slurry of Comparative Example 2 in place of Example 1, the polishing speed was 0.6 μm/hr.

In addition, the central line average surface roughness (Ra) of the polished sapphire surface was 0.503 nm under the same conditions as in Example 2, and these surface roughness was almost the same level as those of polished sapphire by the method and condition of Example 2.

As can be seen from the comparison between Example 1, 2 and Comparative Example 1, 2, when the polishing slurry containing alumina as abrasive grains was used (Example 1,2) upon polishing sapphire, there was little difference in the central line average surface roughness (Ra) of the polished sapphire. On the other hand, in the case of using the polishing slurry containing alumina as abrasive grains (Example 1, 2) , the polishing speed was greater than in the case of using the polishing slurry containing colloidal silica as abrasive grains (Comparative Example 1, 2), and especially, when the polishing slurry adjusted the pH to 12 or more, was used, there was a significant difference in the polishing speed between the case of using alumina abrasive grains and colloidal silica as abrasive grains.

### Example 3

Using the polishing slurry of Example 1, the sapphire just been processed lapping using # 220 of SiC, was polished until it reaches to final polishing surface in the same polishing conditions as in Example 1.

In the meantime, the amount of removed sapphire by the polishing was measured at 15 minute intervals. The result is shown in Table 1. A judgment whether or not the polishing surface has reached to the finish, was carried out by visual observation with an optical microscope (Model

BX6OM manufactured by Olympus Co.).

TABLE 1

| The removed | Accumulated | The amount of |
|---|---|---|
| amount of sapphire | plishing time | accumulation |
| for every 15 | after a polishing | polishes (μm) |
| minutes (μm) | start (minute) | (μm) |
| 1.61 | 15 | 1.61 |
| 2.32 | 30 | 3.92 |
| 2.48 | 45 | 6.41 |
| 2.41 | 60 | 8.81 |
| 2.36 | 75 | 11.17 |
| 2.38 | 90 | 13.55 |
| 2.35 | 105 | 15.90 |
| 2.43 | 120 | 18.33 |
| 2.41 | 135 | 20.74 |
| 2.39 | 150 | 23.13 |
| 1.61 | 15 | 1.61 |
| 2.32 | 30 | 3.92 |
| 2.48 | 45 | 6.41 |
| 2.41 | 60 | 8.81 |
| 2.36 | 75 | 11.17 |
| 2.38 | 90 | 13.55 |
| 2.35 | 105 | 15.90 |
| 2.43 | 120 | 18.33 |
| 2.41 | 135 | 20.74 |
| 2.39 | 150 | 23.13 |

As shown in Table 1, the total removed amount of the sapphire which the final polishing haven't been done yet(the sapphire after just been processed lapping using #220 of SiC) between the start and end of the final polishing step, was approximately 23 μm and the polishing removal amount per each polishing time was approximately constant except during the first 15 minutes. Further, the polishing time required was 2.5 hours and the polishing speed was 9.25 μm/hr during the polishing.

From these result, it was found that the finish polishing can be done in one step, omitting the conventional polishing process using the diamond abrasive grains between before the polishing step (after the state just been processed lapping using #220 of SiC) and the final polishing step.

### Example 4

Using a polishing slurry of Example 1 and the apparatus used in

Example 1, the polishing speed was measured when the polishing pressure is 300 g/cm², 400 g/cm² and 500 g/cm², respectively, and the rotation number of the polishing plate was varied to 60 rpm, 80 rpm and 100 rpm, respectively. The result is shown in Table 2.

TABLE 2

| Polishing | Polishing pressure | | |
|---|---|---|---|
| plate number | 300 | 400 | 500 |
| of rotation | (g/cm²) | (g/cm²) | (g/cm²) |
| 60 | 3.3 | 4.9 | 6 |
| (rpm) | (μm/hr) | (μm/hr) | (μm/hr) |
| 80 | 5 | 5.9 | |
| (rpm) | (μm/hr) | (μm/hr) | |
| 100 | 6.2 | | 9 |
| (rpm) | (μm/hr) | | (μm/hr) |

In Table 2, the blank portion is the polishing conditions were not confirmed in the present Example.

As shown in Table 2, the correlation was found between the polishing speed and the polishing plate number of rotation, and between the polishing speed and the polishing pressure. The polishing speed was 3.3 μ m/hr when the polishing plate number of rotation was 60 rpm and polishing pressure was 300 g /cm². On the other hand, the polishing speed was obtained 9 μm/hr when the polishing plate number of rotation was 100 rpm and the polishing pressure was 500 g /cm², 2.7 times of the former.

From these result, it was found that a further improvement in the polishing speed are possible by adjusting the polishing plate number of rotation and the polishing pressure.

### INDUSTRIAL APPLICABILITY

According to the polishing slurry and the sapphire polishing method using the same of the present invention, significant cost reduction is possible through the improvement of the polishing process, because the polishing process is shortened compared to the conventional sapphire polishing method and the polishing time reduction is possible by applying to the polishing process of sapphire used for the electronic part materials including the substrate for the LED element, the optical component, the watches, the electrically insulating materials, and the window material, etc..

1. A sapphire polishing slurry wherein said slurry contains alumina abrasive grain and the pH of said slurry is in a range of from 10.0 to 14.0.

2. The sapphire polishing slurry according to claim 1, wherein the content of said alumina abrasive grain is in a range of from 0.01 to 50 wt %.

3. The sapphire polishing slurry according to claim 1 wherein the mean particle size is in a range of from 0.05 to 10 # m.

4. The sapphire polishing slurry according to claim 1 wherein the alpha conversion ratio of said alumina crystal phase in said alumina abrasive grain, is in a range of from 1 to 100%.

5. A sapphire polishing method wherein the surface of the saphire is polished by means of Chemical Mechanical Polishing process using the sapphire polishing slurry according to claim 1.
